(19) United States
(12) Patent Application Publication
(10) Pub. No.: US 2010/0271902 A1
(43) Pub. Date: Oct. 28, 2010

(54) APPARATUS AND METHOD FOR PREMIXING LOST CIRCULATION MATERIAL

(76) Inventor: Murphy Braden, Cleveland, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/771,686

(22) Filed: Apr. 30, 2010

Related U.S. Application Data
(63) Continuation-in-part of application No. 11/687,420, filed on Mar. 16, 2007, now abandoned.
(60) Provisional application No. 60/782,799, filed on Mar. 16, 2006.

(51) Int. Cl. B01F 15/02

(52) U.S. Cl. 366/134

(57) ABSTRACT

There is provided herein a system for premixing LCM with drilling mud for use in drilling. In the preferred embodiment, a hopper will contain apertures that release pressurized mud in such a way as to create a swirling vortex of drilling mud and LCM within a central hopper, with the drilling mud/LCM mixture preferably rotating between about 50 and 70 rpm. Adding the LCM to the hopper will mix it thoroughly with the drilling mud before it is introduced into a mud pit, thereby insuring that the final product will well-mixed and further improving the throughput of the overall process.

This application is a continuation-in-part application of U.S. Ser. No. 11/687/420, filed Mar. 16, 2007 which claims priority to expired U.S. Provisional Patent Application Ser. No. 60/782,799, filed Mar. 16, 2006 and incorporates said applications by reference into this document as if fully set out at this point.

### FIELD OF THE INVENTION

The instant invention applies generally to the field of oil and gas well drilling and, more specifically, to an apparatus for replacing lost circulation material (i.e., “LCM”) during drilling.

### BACKGROUND OF THE INVENTION

It is well known that fluid is regularly introduced down hole during the drilling process in order to lubricate the bit, cool it, wash away cuttings, etc. It is similarly well known that some rock formations (e.g., vugular or fractured formations, etc.) are porous to the extent that significant quantities of drilling mud may escape into the nearby rock formation during drilling. It is typical in such instances to continuously replace the drilling mud as it is lost by drawing from mud pits that are located at the well site proximate to the well. Additionally, in many cases, extraneous material is added to the mud before it is sent down into the well, which material is designed to help prevent further loss of drilling fluid from the well bore. The material might be of any type but is often fibrous or plate-like in nature and commonly consists of ground peanut shells, mica, cellophane, walnut shells, calcium carbonate, plant fibers, cottonseed hulls, ground rubber, and/or polymeric materials. Those of ordinary skill in the art will recognize that these materials are added to the mud in the hope that they will help staunch the flow of mud out of the well bore. Such additional materials are known as “lost circulation materials” or “LCM” in the argot of the trade.

Those of ordinary skill in the art will recognize that combining the lost circulation materials with the drilling mud that is destined to go down into the hole can often be problematic. For example, in many instances, the LCM is much lighter than the mud with which it will be mixed. Still, the standard practice is to add the LCM to the mud by dumping sacks of it onto the surface of the mud in the pit and then using rakes and/or a fan-like rotary mechanism at the bottom of the pit to mix the LCM and distribute it uniformly throughout. Needless to say, it often takes some time to thoroughly mix many bags of LCM with the mud. Further, such open air mixing can prove to be a health hazard, as the materials that are added can readily become airborne (e.g., cottonseed hulls) and inhaled by the worker.

Thus, what is needed is a system and method that allows LCM and drilling mud to be mixed more rapidly and effectively. Further, the mixing accessory should be configurable to protect the attendant from exposure to airborne particulate matter.

Heretofore, as is well known in the well drilling industry, there has been a need for an invention to address and solve the above-described problems. Accordingly, it should be now recognized, as was recognized by the present inventor, that there exists, and has for some time, a need for a system that will address and solve the above-described problem.

Before proceeding to the description of the present invention, however, it should be noted and remembered that the description of the invention which follows, together with the accompanying drawings, should not be considered as limiting the invention to the examples (or preferred embodiments) shown and described. This is so because those skilled in the art to which the invention pertains will be able to devise other forms of the invention within the ambit of the appended claims.

### SUMMARY OF THE INVENTION

There is provided herein a system for premixing LCMs before they are added to drilling mud. The instant invention comprises a mixing hopper, which might be open to the atmosphere or enclosed, that includes therein peripherally arranged a plurality of orifices that introduce mud under pressure into the interior of the invention. Further, the orifices will be arrayed in such a fashion as to create a vortex or whirlpool effect within the central hopper of the instant device. In a preferred embodiment, dry LCMs will be added to the hopper where they will be taken into the mud whirlpool that has been created therein. The LCM will then be forced to mix with the mud prior to being introduced into the mud pits.

In some preferred embodiments, the opening into the mixing hopper will be open to the atmosphere. However, in other arrangements, it will be sealed or shut and the LCM will be delivered via closed conduit, thereby protecting the worker against exposure to airborne particulate matter that might otherwise be released when the LCM is added to the hopper.

In another preferred embodiment, the vortex that is created within the hopper will rotating within certain preferred limits. More particularly, the mud orifices and mud pressure will be configured such that the air within the mud vortex does not reach down into the

The foregoing has outlined in broad terms the more important features of the invention disclosed herein so that the detailed description that follows may be more clearly understood, and so that the contribution of the instant inventor to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Further, the disclosure that follows is intended to apply to all alternatives, modifications and equivalents as may be included within the spirit and scope of the invention as defined by the appended claims. Finally, it should be understood that the phraseology and terminology employed herein are for the purpose of description and should not be regarded as limiting, unless the specification specifically so limits the invention.

While the instant invention will be described in connection with a preferred embodiment, it will be understood that it is not intended to limit the invention to that embodiment. On the contrary, it is intended to cover all alternatives, modifications and equivalents as may be included within the spirit and scope of the invention as defined by the appended claims.

### BRIEF DESCRIPTION OF THE DRAWINGS

Other objects and advantages of the invention will become apparent upon reading the following Detailed Description and upon reference to the drawings in which:

FIG. 1 illustrates the general environment of the instant invention including a preferred embodiment thereof.

FIG. 2 contains a detailed view of the preferred embodiment of the instant invention.

FIG. 3 contains a top-down view of the instant invention.

FIG. 4 contains a cross section of the mud conduit inside of the hopper which illustrates in greater detail how orifices have been introduced to provide a directed flow of mod into said hopper.

FIG. 5 is a top down view of another preferred embodiment of the instant invention, wherein two oppositely directed nozzles spray mud onto the interior walls of the hopper in a directional manner.

FIG. 6 illustrates a closed top version of the instant invention.

FIG. 7 contains a schematic illustration of another preferred embodiment in which the mud conduits are largely external to the hopper.

FIG. 8 illustrates a plan view of another preferred aspect of the instant invention which utilizes a domed partial cover to direct LCM to the periphery of the hopper.

FIG. 9 contains a side view of the embodiment of FIG. 8.

FIG. 10 contains a cross sectional view of the embodiment of FIG. 8 which illustrates a preferred mud vortex configuration.

### DESCRIPTION OF THE PREFERRED EMBODIMENTS

Referring now to the drawings wherein the reference numerals indicate the same parts throughout the several views, there is provided a system for automatically premixing LCM before those materials are consigned to a mud pit for subsequent withdrawal during drilling.

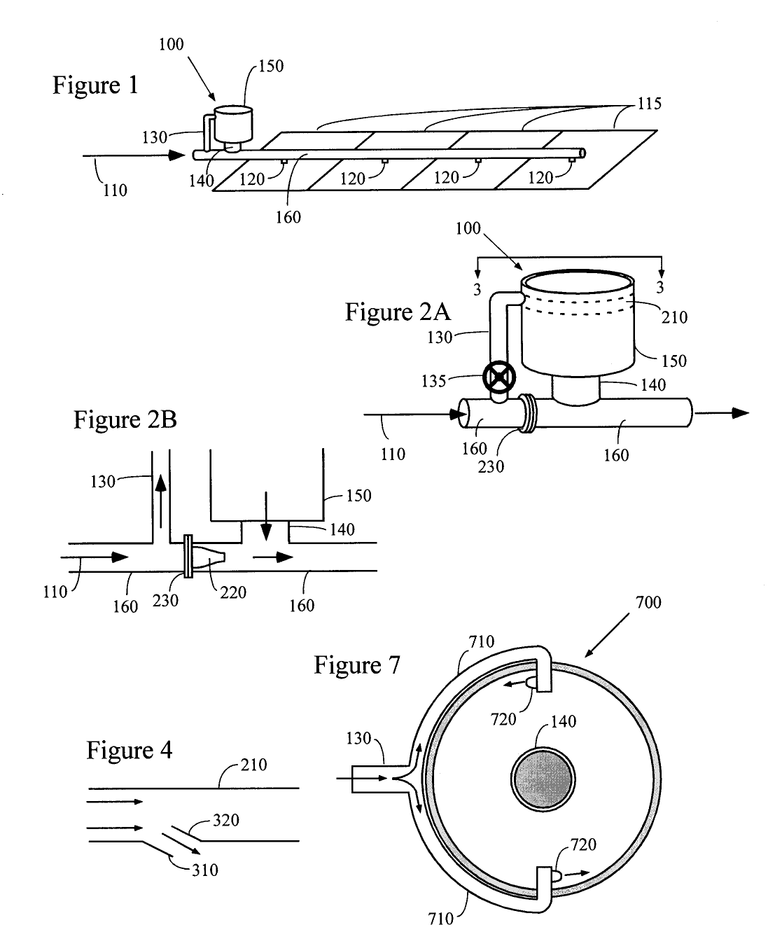

By way of general background and information, FIG. 1 contains a preferred embodiment of the instant invention 100 as might appear on a drill site. As can be seen, there are a number of mud pits 115 which are served by a mud distribution line 160. In most variations, each depositing orifice 120 of the distribution line 160 will be controlled by a separate valve (not shown in this figure), thereby allowing the mud pits 115 to be individually filled. As is generally indicated, drilling mud 110 enters the distribution line at some point upstream from the instant invention 100 and is accumulated in the pits for subsequent withdrawal during drilling. The withdrawal mechanism is well known in the art and is not shown in FIG. 1.

As is indicated in greater detail in FIGS. 2A and 2B, the preferred embodiment of the instant invention is designed to sit in-line with mud distribution line 160. In the preferred embodiment, the mud line will be about six inches in diameter and will carry mud that is pressurized to about 200 psi (thereby providing for a flow of about 1,000 gallons per minute through distribution line 160). Preferably, takeout line 130 will be controlled by a valve 135 and will serve to release pressurized mud to move upward and into the top of the hopper 150. Assisting this process is swedge 220, which is visible in FIG. 2B within the cutaway view of distribution line 160, and which, in one preferred embodiment, narrows the pipe diameter down to about four inches at its downstream terminus. Preferably, the swedge 220 will be installed by cutting the distribution line 160 and installing it therein via six-inch flanges 230, although other installation configurations are certainly possible and could readily be devised by those of ordinary skill in the art.

When drilling mud 110 enters the hopper of the instant invention 150, it is distributed internally by peripheral mud conduit 210 which is preferably located proximate the upper terminus of the hopper 150. The lower portion of the hopper 150 rests atop a connecting pipe 140 which mates with the distribution line 160 to return the mud together with the newly added LCM to the main distribution line.

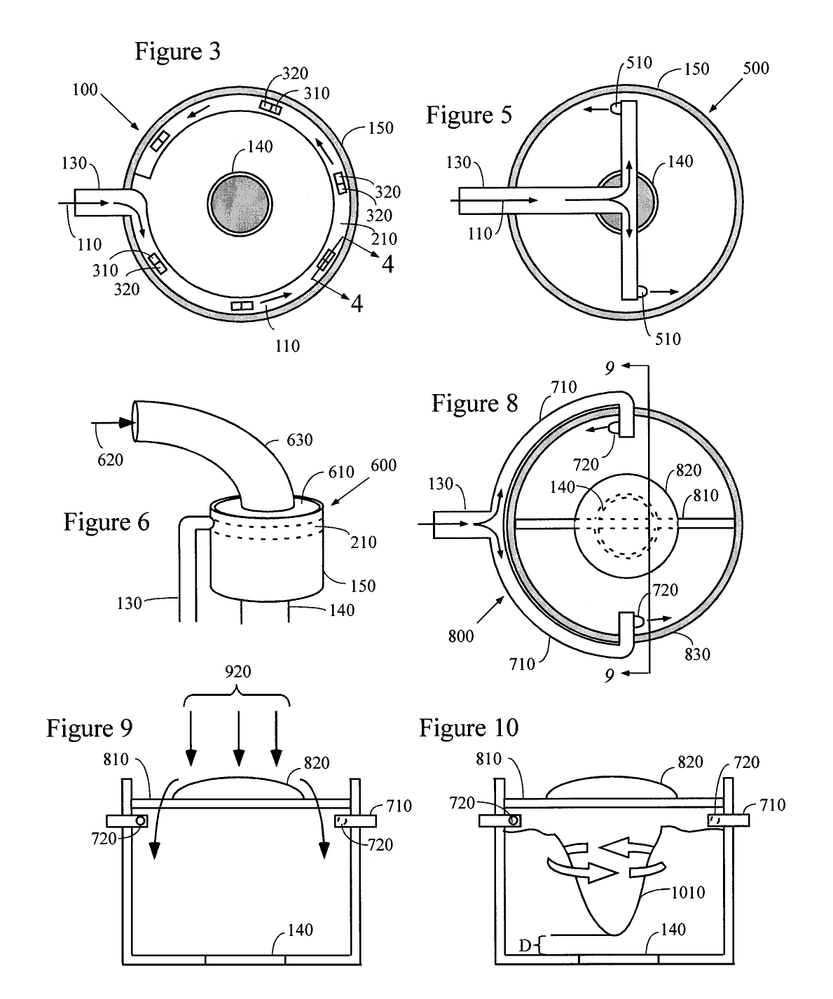

Turning next to FIG. 3, wherein a top view of the instant invention 100 may be found, note that drilling mud 110 enters under pressure by way of takeout line 130 to the interior of the instant hopper 150, where it is diverted into the peripheral mud distribution line 210.

In a preferred embodiment, the mud distribution line 210 will be generally rectangular in cross section, but obviously, other shapes are certainly possible and those of ordinary skill in the art have the capability to readily design such.

In a preferred embodiment, the mud distribution channels 210 will be periodically breached by orifices 320 that allow the mud to escape in a directional pattern into the interior of the hopper. Each orifice 320 will preferably consist of a downward bending 310 and an upward bending 320 element which have been created from the floor of the mud distribution channel 210 by cutting an “H” pattern into the floor thereof. Then, in the preferred embodiment each half of the H will be separately bent down 310 or up 320 in such a manner as to oppose and catch the mud that is streaming through the channel 210. Note that, because the orifices are situated at the periphery of the hopper 150 and each releases mud in a direction that is at least roughly parallel to its inner surface of the hopper 150 at the location of that orifice, this directional release of mud will cause it to swirl around the hopper 150 inner wall, thereby creating a vortex or directional swirling/mixing effect therein. In the preferred arrangement, the mud distribution channel 210 will be closed at its end remote from the mud input point. Of course, those of ordinary skill in the art will recognize that directed nozzles or other directed vents could be used in place of the preferred orifices 320. All that is required is that at sufficient ones of the orifices 320 direct a mud stream in the same rotational direction along the inner wall surface of the hopper 150 so that a vortex or swirling effect is created therein. Thus, for purposes of the instant disclosure it should be understood and remembered that the terms “nozzle”, “vent”, “orifice”, “aperture”, etc., when used in connection with the mud distribution channel 210 should all be broadly interpreted to mean any sort of opening within the channel 210 that allows mud to be released therefrom and which tends to direct a substantial portion of the released mud in a predetermined direction.

Finally, in operation after the distribution line 160 has been activated and pressurized, a worker would operate valve 135 to allow mud to travel upward and into the hopper 150 as has been described previously. At that point, or shortly thereafter, LCM would be added to the top of open hopper 150 by opening large bags of same and depositing their contents into the hopper 150. The swirling whirlpool of drilling mud 110 will then wet the contents of the LCM and eventually wash it down into connecting pipe 140 and subsequently back into the distribution system (e.g., pipe 160) where it will travel until released into a mud pit 115 via aperture 120.

In another preferred arrangement (FIG. 6), there is provided a premixing device 600 substantially as described above but wherein the top is closed and LCM is delivered into the interior of the hopper 150 via conduit 630. Preferably, the LCM will be pressurized at least to the extent necessary to move it along within conduit 630. As is indicated in FIG. 6, preferably the conduit 630 will terminate in a lid 610 which is designed to seal the interior of the hopper 150 against the atmosphere.

Turning next to FIG. 5, according to still another preferred embodiment of the instant invention, there is provided a device substantially as described above but wherein the peripheral distribution channel 210 has been replaced by a “T” configuration wherein each arm of the T terminates in a directed nozzle 510. In operation, this would work similarly to the embodiment discussed previously, in that pressurized mud 110 would move through the T, into its arms, and subsequently be directionally expelled via nozzle 510 in a manner that is designed to create a swirling vortex of drilling mud within the chamber 150. Note that, as was discussed in connection with FIG. 6, the instant embodiment 500 could be either open to the atmosphere or closed depending on the needs of the user. Further, note that the directed nozzles 510 need not be aimed horizontally (or at any other particular angle) and in some cases it might be preferred that they would be aimed at different vertical angles, e.g., in some cases some of the nozzles 510 might be aimed “high” and others “low”. Such an arrangement is fully consistent with the operation of the instant invention so long as the net effect is to create a swirling mud and LCM vortex within the hopper 150. Still further, the nozzles 510 need not be held in a stationary orientation, but each could be manually or automatically aimed at a greater or lesser inclination with respect to the horizontal and/or more toward the hopper 150 outer walls or its center depending on the needs of the particular situation. Once again, all that is required is that the net effect of the nozzles 510 be to create rotational vortex of mud and LCM be created within the hopper 150 when mud is released into the hopper 150 through them. Finally, although in the preferred embodiment the nozzles 510 will be situated within the hopper 150, it should be noted that there is merely a preferred embodiment and there is no particular reason why they could not be situated outside of it, so long as the mud streams generated thereby are directed into the hopper 150 and create a vortex of mud and LCM therein.

As a next preferred embodiment 800 and as is generally illustrated in FIG. 7, there is provided an embodiment wherein the greater part of the mud conduit 710 lies outside of the hopper 830. In this embodiment, the mud conduit 710 divides the drilling mud that is arriving from the takeout line 130 and routes it to opposite sides of the hopper 830. The mud conduit 710 then penetrates the hopper 830 and is terminated by one or more directed nozzles 720. Of course, and as has been discussed previously, these nozzles 720 need to be aimed such that they create a vortex or other rotating action within the hopper 830 in the mud that is released thereby. Needless to say, it is not essential that the nozzles 720 be located on opposite sides of the hopper 830 nor that there be exactly two of them. All that is required is that the nozzles 720 be oriented to create a swirling effect inside of the hopper 830.

According to still another preferred embodiment, there is provided a mixing device 900 that is substantially similar to the embodiment FIG. 7, but wherein only a portion of the hopper opening is covered by a domed LCM diverter 820. A central purpose of the domed diverter 820 is to direct LCM materials that are added to the hopper to its sides where they are more likely to be engaged in the vortex. That is, and as is illustrated more clearly in FIG. 9, when LCM 920 is added to this embodiment, it encounters diverter 820 and, rather than falling through the mud vortex and into the connecting pipe 140, it will instead be directed toward the sides of the hopper 830 where it will encounter the vortex and the mud that is released from the nozzles 720, thereby increasing the possibility that it will be thoroughly wetted. It should be noted that a single support member 810 has been shown but, in practice, two or more would likely be necessary. Finally, although the preferred embodiment for the diverter 820 is a domed shape, other shapes (including flat, pyramidal, etc.) could also be used so long as they force the LCM 920 toward the periphery of the hopper.

Turning next to FIG. 10, in this figure is illustrated an important aspect of the instant invention. More particularly, the instant inventor has found that in order for the mixing process to be most effective, the bottom of the vortex 1010 must effectively terminate above the exit point where the mud leaves the hopper 150. Preferably, the vortex 1010 will effectively terminate some distance above the floor of the hopper 150 (“D” in FIG. 10). The instant inventor has determined that with hoppers of various sizes in order to keep the vortex 1010 from entering the connecting pipe 140 the rotation speed of the mud in the hopper 150 will need to be between about 50 and 70 rpm. More specifically, in the preferred embodiment with a drilling mud having a viscosity of about 28 poise (i.e., dyne-sec/cm²) with no LCM added, the rotation speed will preferably be about 70 rpm. After LCM has been added, the preferred rotation speed will be slower, e.g., about 50 rpm with a viscosity of about 50 poise after adding 40 pounds per barrel of LCM. That being said, those of ordinary skill in the art will recognize that these values are only provided for purposes of illustration and not out of any intent to limit the practice of the invention these specific viscosities. What is important is that the viscosity and rotational speed be selected such that a vortex 1010 is created and its interior (i.e., air-filled portion) terminates above the point the mixed mud and LCM material exits at the bottom of the hopper 150.

Additionally, it should be noted that those of ordinary skill in the art will recognize that, in addition to viscosity, the rate (pressure) with which mud enters the hopper 150 and the angle at which it is directed downward will also have some effect on the rotational speed and depth of the vortex 1010. In a preferred embodiment, where the main mud line has a flow rate of about 375-450 gallons per minute, about ten percent will be diverted into the hopper 150 for mixing, with the remaining 90% being used to carry the mixed product to the pit. This assumes that the nozzles are directed downward at an angle of about a 45°.

Thus, the present invention is well adapted to carry out the objects and attain the ends and advantages mentioned above as well as those inherent therein. While presently preferred embodiments have been described for purposes of this disclosure, numerous changes and modifications will be apparent to those in the art. Such changes and modifications are encompassed within the spirit of this invention as defined by the appended claims.

What is claimed is:

1. A hopper for mixing LCM together with drilling mud, comprising:
(a) a generally cylindrical vertically oriented hopper body,
(i) said hopper body having at least one lower orifice proximate to a lower end of said hopper body, said lower orifice at least for removing mixed LCM and drilling mud from within said hopper body, and,
(ii) said hopper body having at least one upper aperture suitable for receiving the LCM therethrough; and,
(b) a mud conduit positionable within said hopper body, said mud conduit at least for receiving the drilling mud from a mud distribution line and releasing it into said hopper body, wherein
(i) said mud conduit is situated proximate to an inner surface of said hopper,
(ii) said mud conduit is situated proximate to an upper terminus of said hopper body, and,
(iii) said mud conduit has a plurality of directionally oriented mud orifices therein, each of said plurality of mud orifices being above an upper surface of mud in said hopper and oriented to release the drilling mud downwardly and in a direction that is at least approximately parallel to said inner surface of said hopper body, thereby creating a rotational effect within said hopper body, said hopper body and plurality of orifices cooperating together to produce a rotational speed of the drilling mud and LCM mixture within said hopper body of about 50 rpm to 70 rpm when in operation.

2. A hopper for mixing LCM together with drilling mud according to claim 1, wherein said hopper body upper aperture comprises a circular aperture atop said hopper body.

3. A hopper for mixing LCM together with drilling mud according to claim 1, wherein said mud conduit is situated proximate to said inner surface of said hopper throughout substantially its entire length.

4. A hopper for mixing LCM together with drilling mud according to claim 1, wherein said mud conduit is substantially rectangular in cross section.

5. A hopper for mixing LCM together with drilling mud according to claim 4, wherein each of said mud orifices is formed from an “H” shaped cut in a floor of said mud conduit.

6. A hopper for mixing LCM together with drilling mud according to claim 6, wherein is provided a mud distribution line for transporting drilling mud therethrough, wherein said takeout line is in fluid communication with said mud distribution line, and wherein hopper body lower orifice is in fluid communication with said mud distribution line.

7. A hopper for mixing LCM together with drilling mud according to claim 7, wherein said mud distribution line contains at least one swedge therein, and wherein said takeout line is in fluid communication with said mud distribution line at a point upstream of said swedge, and said hopper body lower orifice is in fluid communication with said mud distribution line at a point that is downstream of said swedge.

8. A hopper for mixing LCM together with drilling mud according to claim 1, wherein said hopper body is essentially closed to the atmosphere by a lid and wherein said upper aperture is situated within said lid.

9. A hopper for mixing LCM together with drilling mud according to claim 1, wherein said rotational speed of the drilling mud and LCM mixture within said hopper body is about 50 rpm if said drilling mud and LCM mixture within said hopper body has a viscosity of about 50 poise and wherein said rotational speed of the drilling mud and LCM mixture within said hopper body is about 70 rpm is said drilling mud and LCM mixture within said hopper body is about 28 poise.

10. An apparatus for mixing LCM together with drilling mud, comprising:
(a) a generally cylindrical vertically oriented hopper suitable for containing drilling mud therein and positionable to be situated proximate to a drilling mud distribution line,
(i) said hopper having at least one lower orifice therein, said lower orifice being situated proximate to a bottom of said hopper, and said lower orifice at least for removing mixed LCM and drilling mud from within said hopper, and,
(ii) said hopper having at least one upper aperture suitable for receiving the LCM therethrough; and,
(b) a mud channel, said mud channel at least for receiving the drilling mud under pressure from a mud takeout line and directionally releasing it into said hopper, wherein
(i) said mud takeout line is in fluid communication with said drilling mud distribution line,
(ii) said mud channel is situated proximate to an upper end of said hopper and above a surface of the drilling mud contained within said hopper body, and,
(iii) said mud channel has a plurality of downwardly oriented nozzles for releasing the mud received therein into said hopper, said nozzles being oriented to produce a rotating vortex within the drilling mud and LCM within the hopper, said plurality of nozzles, said mud channel, and said hopper body being configured such that an air-filled interior of said vortex terminates above said lower orifice of said hopper when said apparatus is mixing drilling mud and LCM.

11. An apparatus for mixing LCM together with drilling mud, according to claim 10 wherein said lower orifice is in fluid communication with said mud distribution line and said mixed LCM and drilling mud is returned to said mud distribution line through said lower orifice.

12. An apparatus for mixing LCM together with drilling mud, according to claim 10 wherein each of said oriented nozzles is situated within said hopper.

13. An apparatus for mixing LCM together with drilling mud, according to claim 10, wherein said mud channel is situated entirely within said hopper and wherein said mud channel is substantially rectangular in cross section.

14. An apparatus for mixing LCM together with drilling mud, according to claim 10, wherein each of said mud orifices is formed from an “H” shaped cut in a floor of said mud conduit.

15. An apparatus for mixing LCM together with drilling mud, according to claim 10, further comprising:
(c) a dome-shaped diverter situated within said upper aperture, said diverter being at least for directing LCM toward the periphery of said hopper when LCM is added thereto.

16. A hopper for mixing LCM together with drilling mud according to claim 10, wherein said rotational speed of the drilling mud and LCM mixture within said hopper body is about 50 rpm if said drilling mud and LCM mixture within said hopper body has a viscosity of about 50 poise and wherein said rotational speed of the drilling mud and LCM mixture within said hopper body is about 70 rpm is said drilling mud and LCM mixture within said hopper body is about 28 poise.
